(19) United States
(12) Patent Application Publication
(10) Pub. No.: US 2023/0289700 A1
(43) Pub. Date: Sep. 14, 2023

(54) SYSTEMS AND METHODS FOR CALL COMPLIANCE AND VERIFICATION

(71) Applicant: Capital One Services, LLC, McLean, VA (US)

(72) Inventors: Trent F. HODGES, Richmond, VA (US); Rodney C. BAKER, Goochland, VA (US); James William HOSTETLER, II, Midlothian, VA (US)

(73) Assignee: Capital One Services, LLC, McLean, VA (US)

(21) Appl. No.: 17/690,438

(22) Filed: Mar. 9, 2022

(51) Int. Cl. G06Q 10/06; G06Q 30/00

(52) U.S. Cl. CPC G06Q 10/06395; G06Q 30/018; G06Q 10/06398

(57) ABSTRACT

Systems and methods are disclosed herein for monitoring call compliance and verification. According to some embodiments, there is disclosed a workflow server configured to monitor a communication session between first and second users. The server may also perform a first operation during the communication session, and generate a signal based on the communication session. In response to generating the signal, the workflow server may stop the first operation, disconnect the first and second users, and initiate a second operation for the first user. And, in response to detecting a completion of the second operation, the workflow server reconnects the first and second users, and completes the first operation.

### TECHNICAL FIELD

The present disclosure relates generally to systems and methods for electronic processing activities occurring in connection with data verification, data entry, and data output systems, and in particular, to real-time automated monitoring systems for monitoring and improving live communications, including by providing feedback on communications performance.

### BACKGROUND

Monitoring and improving the performance of a call center employee in handling a call from a customer, typically a customer that has an issue or a problem, has always been a challenge. Supervisors may listen in on a call, and attempt to provide real-time feedback to the employee (hereafter referred to as a ‘call agent’, or simply ‘agent’), but given the number of concurrent calls coming into the call center it is not practical to listen into but a very small number of calls. To handle the large number of concurrent calls, a post-call analytics system may be employed that provides reports on the performance of the calls that have been recorded, but this does not help the agent during a particular call, and thus only acts to provide overall “lessons learned” from an aggregate of calls and history thereof.

Another challenge relates to adherence to regulatory disclosure requirements and notifications to customers. In such cases, customers are typically read a script by an agent and sometimes an agent may forget to do so or the process may be incomplete. Taking sensitive customer data on a call with an agent can expose the customer, agent, and the agent's institution to unnecessary risk relating to the disclosure of sensitive customer information such as personal and financial information.

Therefore, according to the embodiments of the foregoing systems and methods described herein provide for improved monitoring and performance of live calls, in real, or near-real time; improved processing of customer information, and improved presentation and tracking of notifications in accordance with regulatory requirements.

### BRIEF DESCRIPTION OF THE DRAWINGS

FIG. 1 is a block diagram of a distributed computer network incorporating a specific embodiment of a system for validating third party software, according to some embodiments.

FIG. 2 is a block diagram of a validating operation, according to some embodiments.

FIG. 3 is a block diagram of a validating operation, according to some embodiments.

FIG. 4 is a flow diagram illustrating a method for monitoring call compliance and verification operations, according to some embodiments

FIG. 5 illustrates a computer system that carries out monitoring call compliance and verification operations, according to some embodiments.

### DETAILED DESCRIPTION

Examples of applications for the below methods, media, and systems are numerous, but a few are given here merely to indicate possible uses. Other applications will be readily apparent to one of skill in the relevant arts and are likewise contemplated by this disclosure. Moreover, description of “an embodiment” or “one embodiment” should not be construed as limiting the scope of the disclosure, as elements, sub-elements and features of a given embodiment may also be used in other embodiments of the disclosure. While methods described herein may have steps described in a specified order, it will be understood that some of those steps may be re-arranged or performed in a different order. Additionally, embodiments may be given describing applications to particular industries or commercial fields, but scope of the disclosure is not so limited.

Descriptions are given with reference to the figures included herein. When possible and for clarity, reference numbers are kept consistent from figure to figure. Some of the figures are simplified diagrams, which are not to be interpreted as drawn to scale or spatially limiting for the described embodiments. Where appropriate, the particular perspective or orientation of a figure will be given to increase understanding of the depicted features.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The following embodiments describe systems and methods for providing automated assistant for agents that can perform repetitive tasks, take and process private and sensitive user information without exposure to the agent, provide users with key data and disclosures in accordance with regulatory requirements, and monitor conversations with users to drive actions that can increase agent efficiency, improve user experience, and monitor agent performance.

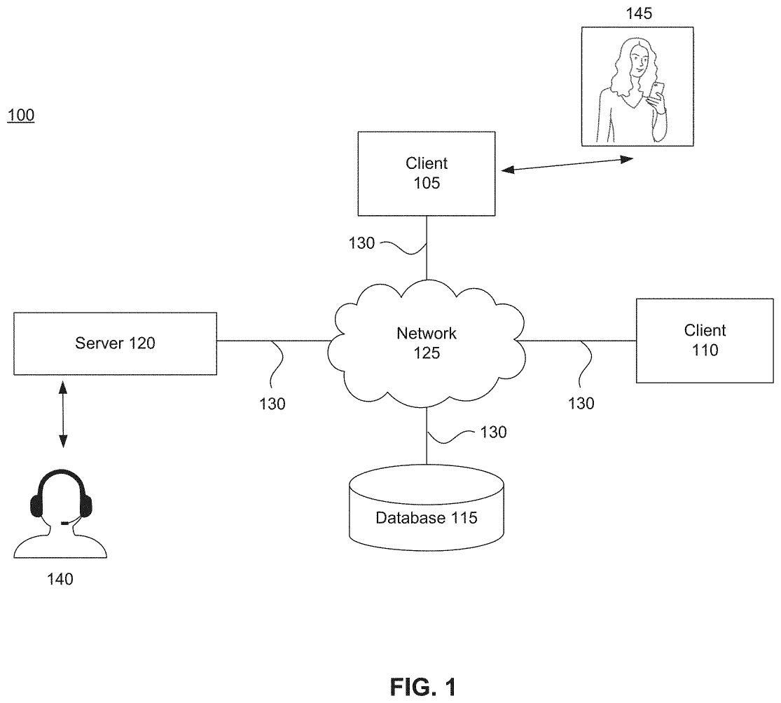

According to some embodiments, FIG. 1 is a simplified block diagram of a distributed computer network 100. For example, computer network 100 can incorporate a specific embodiment of a system for providing the automated assistant. Computer network 100 may include a number of client systems 105 and 110, database 115, and a server system 120 (or server 120) coupled to a communication network 125 via a plurality of communication links 130. Communication network 125 can provide a mechanism for allowing the various components of distributed network 100 to communicate and exchange information with each other.

Continuing with FIG. 1, according to some embodiments, communication network 125 may itself be comprised of many interconnected computer systems and communication links 130. Communication links 130 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, Internet telephony, IP telephony, digital voice, voice over broadband (VoBB), broadband telephony, Voice over IP (VoIP), public switched telephone network (PSTN), and others. While in one embodiment, communication network 125 is the Internet, in other embodiments, communication network 125 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment and does not limit the scope of the systems and methods as recited in the claims. One of ordinary skill in the art would recognize other variations, modifications, and alternatives. For example, more than one server system 120 may be connected to communication network 125. As another example, a number of client systems 105 and 110 may be coupled to communication network 125 via an access provider (not shown) or via some other server system.

According to some embodiments, a user 145 using client systems 105 and 110 may correspond with an agent 140 through server system 120. Aspects of the system may be embodied using a client-server environment or a cloud computing environment.

According to some embodiments, server 120 may be responsible for receiving and processing user calls from client systems 105 and 110, performing processing required to satisfy the calls (e.g., initiate the call response, connect to an agent, request and process user related information, track agent performance, output messages to the user, provide interactive user experiences to the user, and the like). The processing required to satisfy these activities may be performed by server system 120 or may alternatively be delegated to other servers connected to communication network 125. For example, server 120 may be an organization backend server configured to receive and process user calls.

According to some embodiments, client systems 105 and 110 enable users to access and query information or applications stored by server system 120. A client system may be a computing device. Some example client systems include desktop computers, portable electronic devices (e.g., mobile communications devices, smartphones, tablet computers, laptops, etc.) such as the Samsung Galaxy Tab®, Google Nexus devices, Amazon Kindle®, Kindle Fire®, Apple iPhone®, the Apple iPad®, Microsoft Surface®, the Palm Pre™, or any device running the Apple iOS™, Android™ OS, Google Chrome OS, Symbian OS®, Windows Mobile® OS, Windows Phone, BlackBerry OS, Embedded Linux, webOS, Palm OS® or Palm Web OS™.

In a specific embodiment, a “web browser” application executing on a client system enables users to select, access, retrieve, or query information and/or applications stored by server system 120. Examples of web browsers include the Android browser provided by Google, the Safari® browser provided by Apple, Amazon Silk® provided by Amazon, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others (e.g., Google Chrome).

According to some aspects, server system 120 may be configured to proactively read user payment disclosures. This ensures that the user always receives accurate information and that the system accurately tracks payment disclosures in accordance with requisite regulations. This methodology also replaces the need for an agent to read out a disclosure where server system 120 may use natural language processing (NLP) tools to listen and flag any errors in the read disclosure. According to some aspects, server system 120 may be configured to solicit and process user data without an agent on the call being privy to this information (e.g., without agent involvement). For example, server system 120 may prompt the user to input user related information, and, upon receipt of such information, server system 120 may encrypt the user information and/or tokenize the information, and store the user information in a repository (e.g., database 115). Server 120 may process the user information using NLP tools and application programming interfaces (APIs).

According to some aspects, server system 120 may also host voice biometrics capability to support multi function authentication (MFA) procedures for users and agents. According to some aspects, server system 120 may use NLP tools to capture a call session between an agent and a user, determine call context and generate output information to help drive the right system context or support options for the agent to make servicing more efficient. According to some aspects, the server system 120 may also use the NLP tools to capture a call session and track real-time user sentiment, flag the call for escalation or other help when a user, for example, exhibits level of frustration requiring an engagement of manager. According to some aspects, server system 120 may tag call metadata for a time window around the escalation event such that server system 120 may later process the metadata for downstream processing such as training and evaluation purposes. According to some aspects, server system 120 may also use NLP tools to capture the call session and track real-time customer net promoter score. In this regard, server system 120 may provide indicators to the agent on how they are doing during the call. Similarly, server system 120 may then add the captured score to a call metadata and store in database 115 for downstream applications described herein.

According to some aspects, server system 120 deploying tools discussed further herein and providing for call session monitoring, information dissemination, and collection of user information provides a number of advantages over existing systems. For example, server system 120 can ensure adherence to regulatory requirements by providing accurate disclosures to users and by tracking the provided disclosures in compliance with regulatory requirements. According to some aspects, server system 120's ability to decouple the collection of user information from the agent can significantly reduce fraud risk and increase compliance of privacy and other regulatory requirements. It can be appreciated that such decoupling means an agent would not collect and would not be able to view the user information input by the user.

According to some aspects, and from an organizational standpoint, an organization or a call center deploying server system 120 can experience a significant reduction in costs relating to after-the-fact agent tracking and monitoring, compliance monitoring and remedial actions after a call has ended. For example, tools deployed by server system 120 enable the server to proactively detect compliance and agent performance in real-time, and provide real-time solutions that can ensure compliance and improve user experience while still on the call.

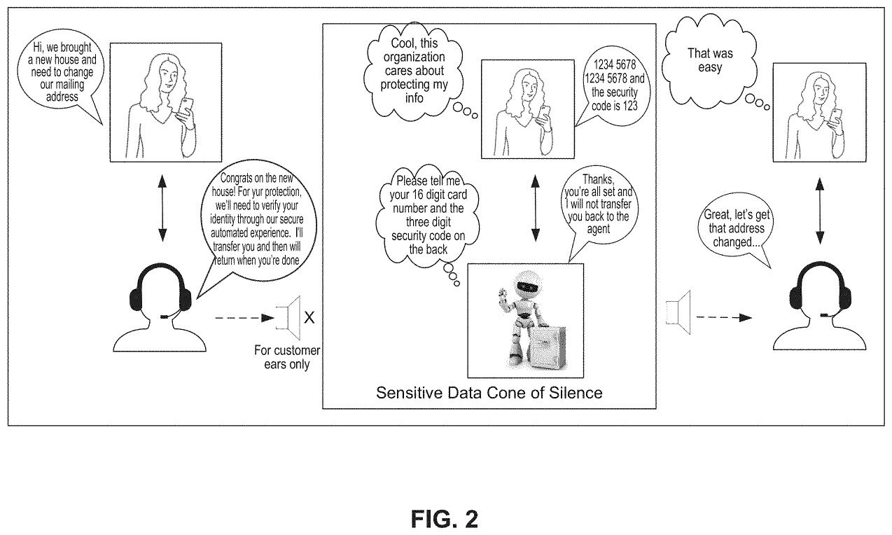

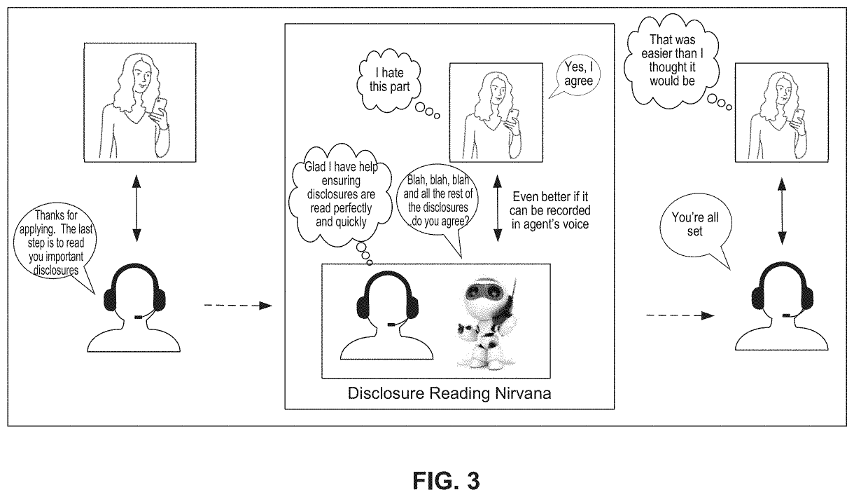

FIGS. 2 and 3 illustrate different scenarios where server system 120 may aid an agent in processing a call and providing enhanced user experience and functionality.

With reference first to FIG. 2, according to some aspects user 145 using client system 110 can call into a call center tasked with handling user calls for an organization. It can be appreciated that such organizations may be any organization conducting business with users, including providing for goods and services to the users. Upon receiving the call, server system 120 may direct the user to the appropriate representative. In some aspects, server system 120 may initially request information from the user in order to direct the user to the appropriate representative.

According to some aspects, when server system 120 receives the user's call, server system 120 may initiate a call session and begin to track the call session. It can be appreciated that by tracking the call session, server system 120 may deploy one or more tools for analyzing call content and call details. For example, server system 120 may initiate an NLP tool configured to capture user input for data processing and/or capture a conversation or transaction between the user and the agent. Server system 120 may also store the output of the NLP tool in a metadata file in a local storage, or in the alternative, in database 115.

Upon collecting initial user information, server system 120 may proceed to identify the appropriate agent 140. According to some aspects, agent 140 may engage user 145 to address any reasons for the call. In one example, user 145 may inform the agent 140 that user 145 bought a house and needs to change the user's mailing address on file. To maintain the confidentiality of the user data, server system 120, monitoring the conversation between agent 140 and user 145 may detect trigger words that would trigger a sensitive data collection event. For example, server system 120 may detect that the user wishes to update an address, determine that the address is sensitive data, and a data collection event may be triggered as will be further described herein. It can be appreciated that the triggered collection event may be done automatically, or may be done by direction of agent 140. For example, upon detecting the user's request to change address, server system 120 may issue a notification to agent 140 to trigger the collection event. Additionally, or in the alternative, agent 140 may choose to trigger the collection event by selecting an option displayed on a user interface engaged by the agent 140.

According to some aspects, triggering the collection event decouples agent 140 from the caller in order for server system 120 to capture the user information. This ensures that sensitive information is securely captured while also reducing any risk of exposure of the user's sensitive information to the agent 140. This also reduces any liability implications to the agent 140, and by extension, to the organization (since the agent will not privy to any of the user's sensitive information).

In one example illustrated in FIG. 2, server system 120, deploying an automated agent assistant, may query user 145 to input user related information in order to authenticate the user 145. User information may include personally identifiable information (PII) including any information about an individual that can be maintained by an agency in order to identify the individual. In some aspects this information may include social security number, phone number, credit card number, account number, and the like. As illustrated in FIG. 2, server system 120, deploying the automated agent assistant, may request that user 145 input their 16 digit credit card number and the three digit security code on the back. According to some aspects, server system 120 may receive the user provided information and compare the received information with stored credit card information. In the event that server system 120 determines a match between the received information and the stored information, server system 120 may re-connect agent 140 with user 145 in order to continue the call session. In this example, agent 140 may then proceed to change the user's address.

It can be appreciated that in the event that user data cannot be verified, server system 120 may request that user 145 provide additional and/or different PII information in order to facilitate the authentication. In cases where user authentication continues to fail, server system 120 may transfer user 145 to an agent with a higher level of clearance than agent 140 (e.g., supervisor, etc.) that can receive the user's PII information and authenticate the user.

FIG. 3 illustrates an exemplary scenario between agent 140 and user 145 where user 145 is to receive a disclosure. According to some aspects, server system 120, either automatically through NLP detection or through agent trigger, can engage user 145 in order to output a specific disclosure (e.g., user agreement, terms and conditions, guidelines, etc.) in accordance with a regulatory requirement. Upon triggering of a read out operation, server system 120 may track the output and notate that user 145 received the required disclosure. Server system 120 may document this activity in the user's file for the record. According to some aspects, ensuring compliance with regulatory requirements is vital for an agencies compliance requirements with specific regulations. Accordingly, it can be appreciated that by tracking of the provided disclosures, server system 120 can ensure and document an agency's compliance with guidelines as well as ensure that the user receives accurate disclosure.

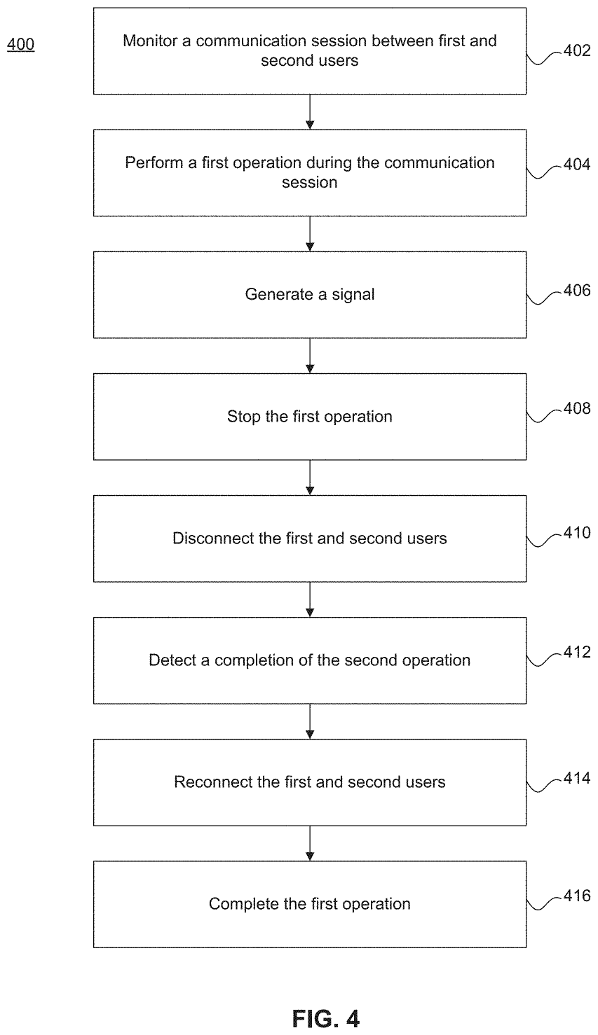

FIG. 4 illustrates a method 400 for monitoring call compliance and verification according to some embodiments. It is to be appreciated that not all operations need be performed or performed in the order shown.

According to some aspects, method 400 may be carried out by server system 120. It can be appreciated that server system 120 may also be referred to as a workflow server configured to process and monitor a workflow of a call session between an agent of an agency and a user.

According to some aspects, method 400 may include monitoring, by server system 120, a communication session between first and second users, as illustrated in step 402.

According to some aspects, the communication session may be a received call from a user, e.g., user 145, requesting to interact with the agency. It can be appreciated by those skilled in the art that the agency may be any entity that may conduct business with user 145, or provide any type of interaction or provide any type of service for user 145 and/or on behalf of user 145. Such entities may include information technology entities, banks and financial entities, goods providing entities, and other service rendering entities. User 145 may contact the agency for a plurality of reasons, including, for example, to resolve an issue, to update user information, to conduct a transaction, and the like. In this example, the first user may be user 145 and the second user may be agent 140.

According to some aspects, method 400 may include performing, using the workflow server 120, a first operation during the communication session, as illustrated in step 404.

According to some aspects, the communication session may be a call log initiated by server system 120 connecting user 145 with agent 140.

According to some aspects, the first operation may be the actual connection between user 145 and agent 140.

According to some aspects, the first operation may include activating an operation for capturing metadata associated with the call session. For example, the first operation may include using a natural language processing (NLP) tool to capture and track conversation details between user 145 and agent 140. Capturing and tracking conversation details may enable server system 120 to perform downstream applications, including, for example, capturing user sentiment, accuracy of disclosures, monitoring agent performance, and triggering events such as escalation events and other events relating to decoupling of user 145 and agent 140. As described herein, decoupling user 145 and agent 140 may be performed in certain operations that require the input of sensitive information or PII.

According to some aspects, method 400 may include generating, based on the communication session by the workflow server 120, a signal, as illustrated in step 406. According to some aspects, the signal may be generated based on a detection by the workflow server 120 of a trigger event or a condition. As can be appreciated by those skilled in the art, the trigger event or condition may include detection of user sentiment or key words/phrases detected using the NLP tool to generate the signal. Such detected words/phrases may correspond to request to input sensitive user information.

According to some aspects, when generating the signal, method 400 may include performing a series of steps by the workflow server 120 to activate an automated agent assistant that can provide additional services. Among such services performed by the automated agent include capturing sensitive user information, providing disclosure presentations and the like.

According to some aspects, method 400 may include stopping the first operation, as illustrated in step 408. According to some aspects, stopping the first operation may include stopping a recording of the call session between the user 145 and the agent 140. This may enable the system to transition to further downstream activities that capture user sensitive information without necessitating the recording of such information.

According to some aspects, method 400 may also include disconnecting, using the workflow server 120, users, as illustrated in step 410. According to some aspects, the decoupling of user 145 and agent 140, for example, is useful for privacy and compliance purposes. For example, decoupling reduces exposing sensitive data to agents or third parties and reduces fraud risk liabilities for the agency. As another example, the decoupling may allow for the activation of the automated agent assistant, which may reduce the need for reactive controls that ensure the agency meets regulatory requirements such as reading disclosures.

According to some aspects, by deploying the automated agent assistant, the agency, through server system 120, can ensure that user 145 is provided all required regulatory disclosures and also track the dissemination of such disclosures for compliance purposes.

According to some aspects, server system 120 may provide a segregated voice-bot experience to collect PII data from users without agent intervention. Server system 120 may also provide proactive voice-bot narration of disclosures along with automatic user consent capture, thereby improving compliance tracing and recordation. In doing so, server system 120 can simplify agent processes and provide customers a better protection of PII data. Through the systems and methods disclosed herein, the agency can provide a uniform customer experience across all voice channels. The systems and methods disclosed herein may also reduce fraud and increase data security and regulatory compliance.

According to some aspects, method 400 may include initiating, using the workflow server 120, a second operation for the user 145, as illustrated in step 412. As described herein, the second operation for the user 145 may be an operation to capture PII data through the automated agent assistant. As described herein, according to some aspects, the second operation may be a message provided by the workflow server 120 to the user 145, the message being associated with a set of one or more disclosure requirements.

According to some aspects, workflow server 120 may monitor the progress of the second operation and detect when the second operation is complete. In one example, when a disclosure is performed (e.g., providing a scripted terms and conditions reading), the workflow server 120 may perform additional operation to rejoin user 145 with agent 140. For example, when detecting the completion of the second operation, method 400 may also include reconnecting agent 140 and user 145, as illustrated in step 414 and resume the first operation until completion, as illustrated in step 416.

According to some aspects, upon detecting that the requisite disclosure has been provided to the user 145, the workflow server 120 may reestablish the communication session between user 145 and agent 140 to resume the call session. According to some aspects, the workflow server 120 may also resume the recording operation of the communication session.

According to some aspects, the method 400 may also include modifying a portion of the message with customer specific information and/or generating a notification to the agent 140 indicating that the message was received and acknowledged by the user 145 in compliance with a regulatory requirement. This may be, for example, where user 145 is provided a regulatory disclosure and server system 120 informs the agent 140 that user 145 received and acknowledged the disclosure.

According to some aspects, the second operation may be a message output by the workflow server 120 to the user 145, the message providing options available to the user 145 for responding to the message. According to some aspects, the options may include inputting PII data and other user specific information. It can be appreciated that this is but one example and the options available to the user may include selections from a different menu provided by the workflow server, including, for example, resolution options to the call including escalation and/or termination of the call.

According to some aspects, although not shown in FIG. 4, method 400 may also include receiving a response from the user 145 corresponding to a selection of one of the presented options, and processing the response to determine a completion state of the second operation. According to some aspects, when the user 145 makes a selection or inputs PII data, the workflow server may determine that the requisite information has been captured and begin to transition the first user to the agent 140.

It can be appreciated in accordance with the disclosure herein, generating the signal may include detecting, using natural language processing (NLP) in the workflow server 120, a word string within the communication session, choosing the second operation based on the word string, and providing the first user a notification indicating the initiation of the second operation. For example, the word string may correspond to the user agreeing to provide PII information, thereby triggering server system 120 to activate the automated agent assistant and carry out the related activities described herein.

According to some aspects, the second operation may include capturing personal data of the user 145 or initiating a second communication session with a third user. In this context, the third user may be a supervisor of agent 140.

According to some aspects, server system 120 may collect confidential information from the user 145 during the second operation (e.g., when automated agent assistant is deployed). According to some aspects, system 120 may verify provided information in database 115 and may request supplemental information if escalated verification is needed (e.g., also verify date of birth, etc.) for a particular or sensitive account action (e.g., address or name change). In this regard, server system 120 may also restrict the agent 140's access of the collected information during completion of the first operation. For example, during the second operation, agent 140 is disconnected from the call with user 145 and would therefore not be able to hear what information the user 145 provides. Upon collection of the requested information, server system 120 may indicate, via agent portal/agent interface, that the requisite information has been collected. Server 120 may, in a non-limiting example, indicate this by showing a check mark or a green light next to where the requested information may be displayed.

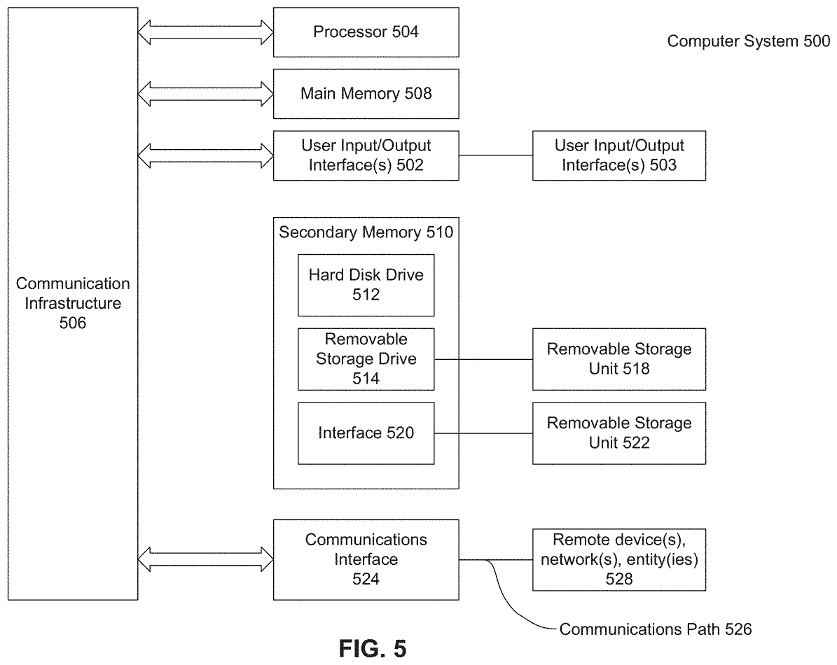

FIG. 5 illustrates a computer system 500 that can be used to carry out the operations of FIGS. 1-4 for monitoring call compliance and verification and can be used to carry out MFA operations (e.g., fingerprint, facial recognition, retinal scan, etc.), according to some embodiments. Various embodiments of the disclosure may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 502, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random-access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein. For example, the instructions, when executed by one or more processors, cause the processors to perform a method for managing third party applications on a computing apparatus as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system embodiments other than those described herein.

Descriptions to an embodiment contemplate various combinations, components and sub-components. However, it will be understood that other combinations of the components and sub-components may be possible while still accomplishing the various aims of the present application. As such, the described embodiments are merely examples, of which there may be additional examples falling within the same scope of the disclosure.

What is claimed is:

1. A computer-implemented method comprising:
monitoring, by a workflow server, a communication session between first and second users;
performing, using the workflow server, a first operation during the communication session;
generating, based on the communication session by the workflow server, a signal;
in response to generating the signal:
stopping, using the workflow server, the first operation,
disconnecting, using the workflow server, the first and second users, and
initiating, using the workflow server, a second operation for the first user;
in response to detecting a completion of the second operation:
reconnecting, using the workflow server, the first and second users, and
completing, using the workflow server, the first operation.

2. The computer-implemented method of claim 1, wherein the second operation is a message provided by the workflow server to the first user, the message being associated with a set of one or more disclosure requirements.

3. The computer-implemented method of claim 1, wherein:
the second operation is a message output by the workflow server to the first user, the message providing options available to the first user for responding to the message; and
the computer-implemented method further comprises:
receiving a response from the first user corresponding to a selection of one of the provided options; and
processing the response to determine a completion state of the second operation.

4. The computer-implemented method of claim 2, further comprising:
modifying a portion of the message with customer specific information.

5. The computer-implemented method of claim 2, further comprising:
generating a notification to the second user indicating that the message was received and acknowledged by the first user in compliance with a regulatory requirement.

6. The computer-implemented method of claim 1, wherein generating the signal further comprises:
detecting, using natural language processing (NLP) in the workflow server, a word string within the communication session;
choosing the second operation based on the word string; and
providing the first user a notification indicating the initiation of the second operation.

7. The computer-implemented method of claim 1, wherein the second operation comprises capturing personal data of the first user or initiating a second communication session with a third user.

8. The computer-implemented method of claim 1, further comprising:
collecting confidential information from the first user during the second operation; and
restricting access of the collected information during completion of the first operation.

9. A computing apparatus, comprising:
one or more processors; and
one or more memories having instructions stored thereon that, when executed by the one or more processors, cause the one or more processors to:
monitor a communication session between first and second users;
perform a first operation during the communication session;
generate, based on the communication session, a signal;
in response to generating the signal:
stop the first operation,
disconnect the first and second users, and
initiate a second operation for the first user; and
in response to detecting a completion of the second operation:
reconnect the first and second users, and
complete the first operation.

10. The computing apparatus of claim 9, wherein the second operation is a message provided by the computing apparatus to the first user, the message being associated with a set of one or more disclosure requirements.

11. The computing apparatus of claim 9, wherein:
the second operation is a message output by the computing apparatus to the first user, the message provides options available to the first user for responding to the message;
the one or more processors are further configured to
receive a response from the first user corresponding to a selection of one of the provided options; and
process the response to determine a completion state of the second operation.

12. The computing apparatus of claim 10, wherein the one or more processors are further configured to:
modify a portion of the message with customer specific information.

13. The computing apparatus of claim 10, wherein the one or more processors are further configured to:
generate a notification to the second user indicating that the message was received and acknowledged by the first user in compliance with a regulatory requirement.

14. The computing apparatus of claim 9, wherein when generating the signal, the one or more processors are further configured to:
detect, using natural language processing (NLP) run by the computer apparatus, a word string within the communication session;
choose the second operation based on the word string; and
provide the first user a notification indicating the initiation of the second operation.

15. The computing apparatus of claim 9, wherein the second operation comprises capturing personal data of the first user or initiating a second communication session with a third user.

16. The computing apparatus of claim 9, wherein the one or more processors are further configured to:
collect confidential information from the first user during the second operation; and
restrict access of the collected information during completion of the first operation.

17. A non-transitory computer-readable medium including instructions that, when executed by one or more processors, cause the processors to perform a method for managing third party applications on a computing apparatus, the method comprising:
monitoring, by a workflow server, a communication session between first and second users;
performing, using the workflow server, a first operation during the communication session;
generating, based on the communication session by the workflow server, a signal;
in response to generating the signal:
stopping, using the workflow server, the first operation,
disconnecting, using the workflow server, the first and second users, and
initiating, using the workflow server, a second operation for the first user;
in response to detecting a completion of the second operation:
reconnecting, using the workflow server, the first and second users, and
completing, using the workflow server, the first operation.

18. The non-transitory computer-readable medium of claim 17, wherein the second operation is a message provided by the workflow server to the first user, the message being associated with a set of one or more disclosure requirements.

19. The non-transitory computer-readable medium of claim 18, wherein the operations further comprise:
modifying a portion of the message with customer specific information.

20. The non-transitory computer-readable medium of claim 18, wherein the operations further comprise:
generating a notification to the second user indicating that the message was received and acknowledged by the first user in compliance with a regulatory requirement.
